(19) United States
(12) Patent Application Publication
(10) Pub. No.: US 2008/0234084 A1
(43) Pub. Date: Sep. 25, 2008

(54) WHEEL WITH FLOATING SLEEVE

(76) Inventor: Mark Ackerman, Lincoln, NE (US)

Correspondence Address: MARK ACKERMAN, 7600 WREN CT., LINCOLN, NE, 68506, US

(21) Appl. No.: 11/687,797

(22) Filed: Mar. 19, 2007

(51) Int. Cl. F16H 55/17; F16H 7/00

(52) U.S. Cl. 474/148; 474/152

(57) ABSTRACT

A wheel, such as a pulley or a sprocket, includes a hub and a sleeve. The hub has an outer surface with a plurality of substantially axially aligned teeth. The sleeve has: (a) an inner surface with a plurality of substantially axially aligned grooves that engage the teeth of the hub; and, (b) an outer band engagement surface that engages a band, such as a belt or a chain. As the band tends to become misaligned with respect to the wheel, the sleeve automatically moves axially with respect to the hub to correct the misalignment.

### I. BACKGROUND OF THE INVENTION

A. Field of Invention

This invention pertains to the art of methods and apparatuses regarding belt and chain systems, and more particularly to methods and apparatuses regarding self-aligning pulleys and sprockets.

B. Description of the Related Art

Belt systems are in widespread use. For example, within the automotive industry, systems consisting of one or more drive pulleys, one or more driven pulleys, one or more idler pulleys, and a belt that connects the pulleys are utilized in transmission systems. The belts used in such applications may be composed of a resilient elastomer reinforced with one or more reinforcing members extending therealong. Generally, one or more rows of teeth are uniformly spaced apart in the longitudinal direction along one surface of the belt, the opposite surface being substantially smooth and toothless. The teeth positively engage complimentary grooves within the drive and driven pulleys as the belt rotates. The drive and driven pulleys are thus rotated in a common direction in synchronous fashion. In other applications, it is common to counter-rotate a driven pulley off a drive pulley through the use of a two sided drive belt. The drive pulley generally drives the belt by engagement with one belt surface and the driven pulley is engaged by the opposite surface of the belt. Counter-rotation of the driven pulley relative to the drive pulley results. A method and system for achieving counter-rotation between a drive pulley and driven pulley(s) in a synchronous positive drive belt system is provided in U.S. Pat. No. 6,866,603 titled COUNTER-ROTATIONAL DRIVE BELT SYSTEM AND METHOD, which is hereby incorporated by reference.

Chain systems are also in widespread use. Similar to belt systems, they generally consist of one or more drive sprockets, one or more driven sprockets, and a chain that connects the sprockets.

Many belt and chain systems work well for their intended purpose though they are known to have disadvantages. One disadvantage is related to the misalignment problems that often occur. The belt or chain can become misaligned relative to the pulleys or sprockets for many reasons including tolerance stackups, installation error, bend supports, and component wear. Misalignments can cause reduce the efficiency of the belt or chain system and can cause premature wear of the components. In order to correct the misalignment, the pulleys or sprockets must be carefully repositioned. Such repositioning requires that the belt or chain system must be stopped and is often labor intensive. What is needed, then, is a belt/chain system that can easily adjust to misalignments without the need to stop the system.

Another disadvantage to known belt and chain systems is the cost of replacement parts. When the pulley channel that receives the belt or the sprocket teeth that receive the chain are damaged or worn, the entire pulley or sprocket must be replaced. This is relatively expensive especially given that often the hub of the pulley or sprocket remains in good working condition. What is needed is a pulley/sprocket that permits the hub to be reused.

### II. SUMMARY OF THE INVENTION

According to one embodiment of this invention, a wheel comprises: a hub comprising an outer surface having a plurality of substantially axially aligned teeth; a sleeve comprising: (a) an inner surface having a plurality of substantially axially aligned grooves that engage the teeth of the hub; and, (b) an outer band engagement surface. The sleeve can move axially with respect to the hub while the wheel transmits torque between the hub and an associated band.

According to another embodiment of this invention, the sleeve is formed of a plastic.

According to another embodiment of this invention, the wheel is a pulley.

According to yet another embodiment of this invention, the wheel is a sprocket.

According to another embodiment of this invention, a band system comprises: a first wheel; a second wheel comprising: (1) a hub comprising an outer surface having a plurality of substantially axially aligned teeth; (2) a sleeve comprising: (a) an inner surface having a plurality of substantially axially aligned grooves that engage the teeth; and, (b) an outer band engagement surface; and, a band that operatively engages the first wheel and that comprises at least one surface having a plurality of teeth that engage the outer band engagement surface of the sleeve of the second wheel. The sleeve of the second wheel can move axially with respect to the hub of the second wheel while the second wheel transmits torque between the hub of the second wheel and the band.

According to another embodiment of this invention, a method comprises the steps of: providing a first wheel; providing a second wheel comprising a hub and a first sleeve having an inner surface that engages the hub and an outer band engagement surface; providing a band that operatively engages the first wheel and the band engagement surface of the second wheel; driving the band system to thereby transmit torque between the band and the first and second wheels; and, moving the first sleeve axially with respect to the hub to align the band with respect to the first and second wheels.

According to another embodiment of this invention, the first sleeve can be easily replaced with a second sleeve having an inner surface that engages the hub and an outer band engagement surface.

According to still another embodiment of this invention, the movement of the first sleeve axially with respect to the hub, occurs automatically as the band tends to become misaligned with respect to the first and second wheels. The wheel thus self-aligns.

One advantage of this invention is that a belt/chain system can easily adjust to misalignments without the need to stop the system.

Another advantage of this invention is that when replacement is necessary, the hub of the pulley/sprocket can be reused as only the sleeve need be replaced.

Another advantage of this invention is that for relatively high volumes, the plastic sleeve may be injection molded to lower costs.

Another advantage of this invention is that for relatively low volumes, the plastic sleeve may be machined at a lower cost than metal.

Another advantage of this invention is that the plastic sleeve has a lower elastic modulus than a metal component and this increases the load sharing ability of the sleeve with the relatively low elastic modulus belt.

Yet another possible advantage of this invention is that the plastic sleeve may decrease belt debris damage.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic representation of a band system in the form of a belt system including a band in form of a belt and wheels in the form of pulleys.

FIG. 2 is a schematic representation of a band system in the form of a chain system including a band in form of a chain and wheels in the form of sprockets.

FIG. 3 is a plan view of a wheel according to one embodiment of this invention.

FIG. 4 is a side perspective view of the wheel shown in FIG. 3.

FIG. 5 is a side perspective view of the hub alone shown in FIG. 3.

FIG. 6 is a side perspective view of the sleeve alone shown in FIG. 3.

### IV. DEFINITIONS

The following terms may be used throughout the descriptions presented herein and should generally be given the following meaning unless contradicted or elaborated upon by other descriptions set forth herein.

“Band” refers to a continuous strip of material or materials used to transmit a force between wheels.

“Belt” refers to a band formed at least in part from one or more flexible materials.

“Chain” refers to a band formed by connecting a series of links together.

“Hub” refers to the central portion of a wheel.

“Pulley” refers to a wheel with an outer portion used to engage a belt.

“Sprocket” refers to a wheel with an outer portion used to engage a chain.

“Wheel” refers to a substantially circular disk that rotates about an axis.

### V. DETAILED DESCRIPTION OF THE INVENTION

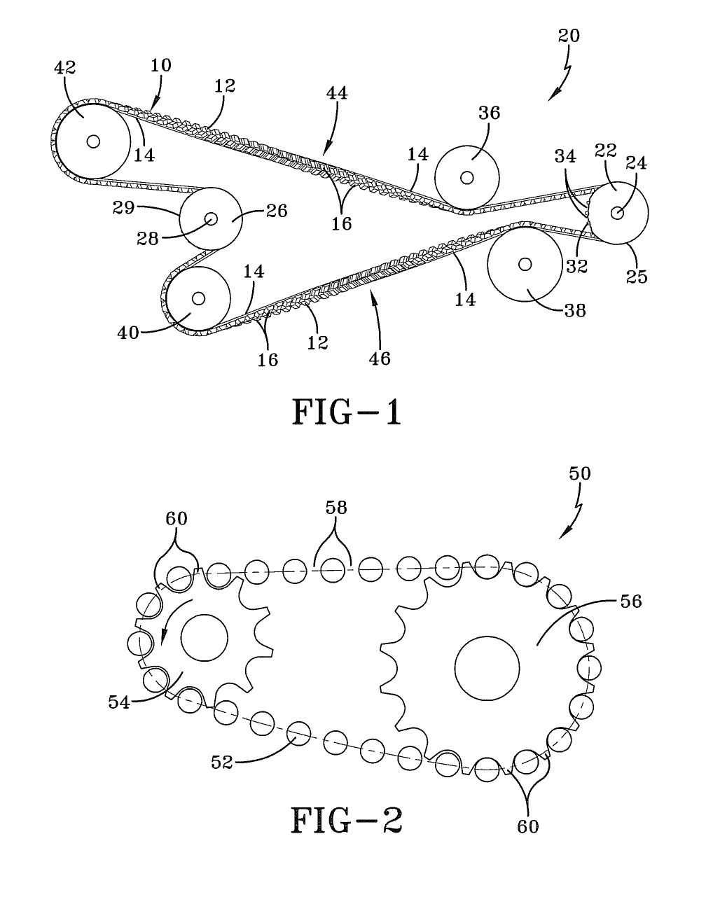

Referring now to the drawings wherein the showings are for purposes of illustrating embodiments of the invention only and not for purposes of limiting the same, FIG. 1 is a schematic representation of a band system 20 in the form of a belt system 20 including a band in form of a belt and wheels in the form of pulleys. It should be noted that it is known in some applications, such as some synchronous belt systems, to refer to the wheel that receives the belt as a “sprocket.” In order to clarify the meaning of terms for this patent, however, “sprocket” refers to a wheel that engages a chain and “pulley” refers to a wheel that engages a belt. These terms are defined above. Note that this means the broader term “wheel” encompasses a sprocket, a pulley, and all other components that meet the definition of wheel provided above. Similarly and also in order to clarify the meaning of terms for this patent, “chain” refers to a band formed by connecting a series of links together and “belt” refers to a band formed at least in part from one or more flexible materials. This means that the broader term “band” encompasses a chain, a belt, and all other components that meet the definition of band provided above.

With continuing reference to FIG. 1, while the belt system 20 shown is a counter-rotation design, it should be noted that this invention will work well with any type of belt system using at least one pulley wheel. The belt 10 shown is a synchronous drive belt of a type commonly used in conventional drive systems such as in automotive and motorcycle power transmission applications. The belt 10 may have a toothed surface 12 and a planar opposite untoothed surface 14. Spaced apart along the surface 12 are a series of drive teeth 16. The belt 10 may be made of a resilient elastomer and reinforced with a longitudinal tensile member made up of a plurality of cords of a high elastic modulus. The belt 10 may have adjacent rows of teeth 16, as shown, or a single row of teeth if required or desired. The teeth 16 may be uniformly spaced apart in the longitudinal direction. The belt system 20 my also include a drive pulley 22 having a center shaft 24 and an outer band engagement surface 25. One or more driven pulley(s) 26 may be driven by the belt 10, each driven pulley having a center shaft 28 and an outer band engagement surface 29. The outer band engagement surfaces 25, 29 of the drive pulley 22 and the driven pulley 26 each include a perimeter series of complimentary teeth 32 evenly spaced apart about an outer circumference. Adjacent teeth 32 are separated by a cavity 34 having a prescribed geometry and configuration. The cavities 34 are shaped to receive in meshing engagement the teeth 16 of the belt 10. One or more idler, or routing, pulleys 36, 38, 40, and 42 may be deployed as needed for a particular application.

Still referring to FIG. 1, the belt system 20 uses the belt 10 in a continuous loop, as shown. The belt toothed side 12 engages the toothed perimeter 25 of the drive pulley 22 which is rotatably driven thereby. The belt 10 is routed across the pulley 36 and proceeds to pulley 42. Substantially midway between the pulley 36 and idler pulley 42 a first 180 degree twist 44 is introduced into the belt such that the downward facing toothed surface at the pulley 36 is upwardly oriented at pulley 42. The toothed surface 12 of the belt 10, accordingly, that was downwardly oriented leaving pulley 36, by virtue of twist 44, is oriented upward at idler pulley 42. The non-toothed smooth surface 14 of the belt 10 engages pulley 42 and is routed toward the driven pulley 26. It will be appreciated that a clockwise rotation of the driver pulley 22 will cause the belt segment extending to pulley 36 and pulley 42 to move to the right as seen in FIG. 1. Rightward movement of the belt causes pulley 36 to rotate counterclockwise. The twist 44 reorients the belt prior to the idler pulley 42 and driven pulley 26 such that the belt is moving leftward as it routes over pulley 26. The toothed surface 12 of the belt 10 engages the driven pulley 26 and causes it to rotate counterclockwise. Pulley 26 is thereby driven in a direction opposite to the drive pulley 22. As the belt 10 loops around pulley 26, and is routed back to the drive pulley 22, it passes and engages idler pulley 40. Substantially midway between idler pulley 40 and pulley 38, a second 180 degree twist is introduced into the belt as shown at 46. The reoriented belt 10 is routed over pulley 38 and returns to driver pulley 22. The purpose of the twin twists 44, 46 is to allow counter-rotation of the driven pulley 26 relative to driver pulley 22.

With reference now to FIG. 2, a schematic representation of a band system 50 in the form of a chain system 50 including a band in form of a chain and wheels in the form of sprockets is shown. While the chain system 50 shown is a simple two sprocket design, it should be shown that this invention will work well with any type of chain system using at least one sprocket wheel. A chain 52 in the form of a continuous loop, as shown, connects a drive sprocket 54 to a driven sprocket 56. The chain 52 may be formed by connecting links together as is well known in the art. The chain 52 has openings 58 that receive teeth 60 formed on the outer band engagement surfaces of the drive and driven sprockets 54, 56. Rotation of the drive sprocket 54 rotates the chain 52 and thus the driven sprocket 56 in a manner well known in the art.

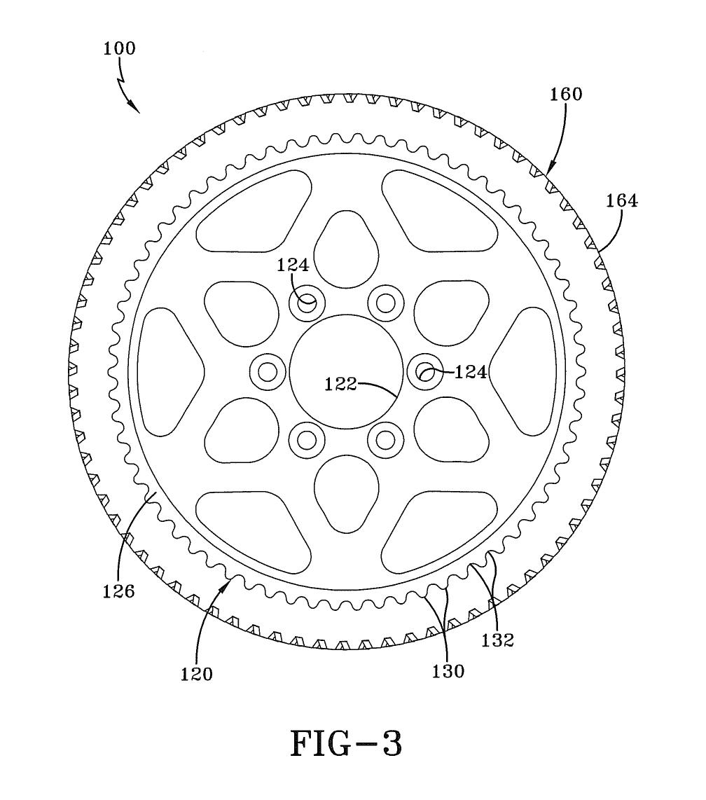

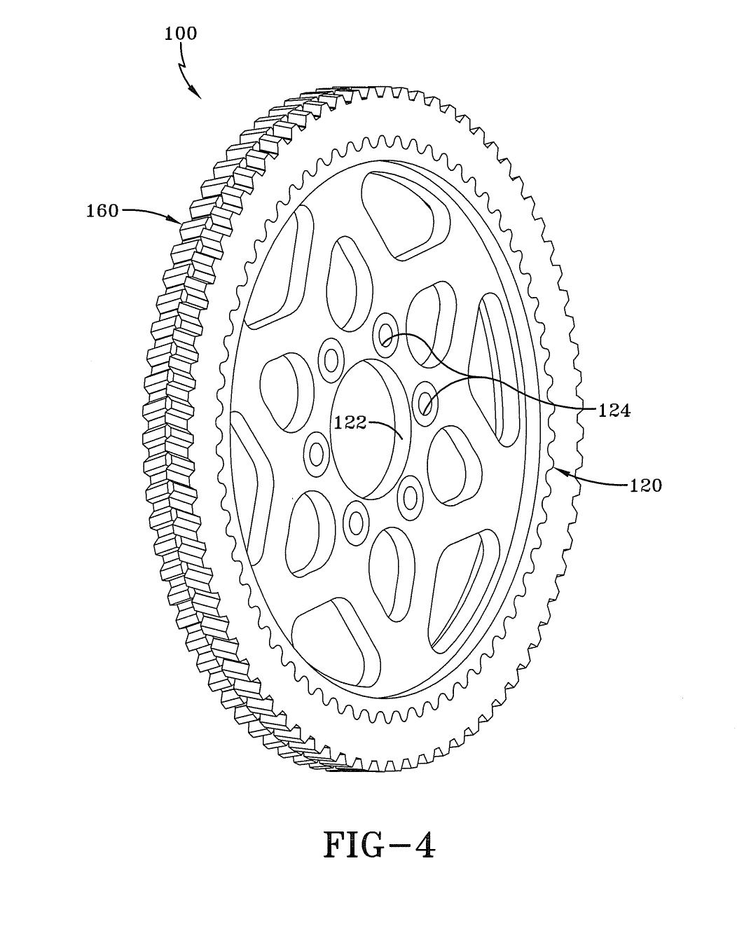

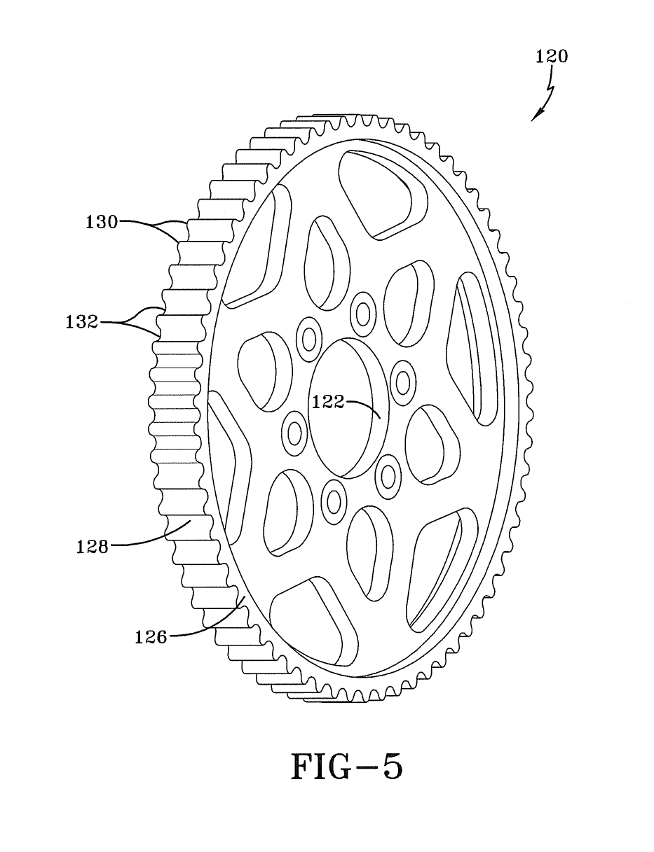

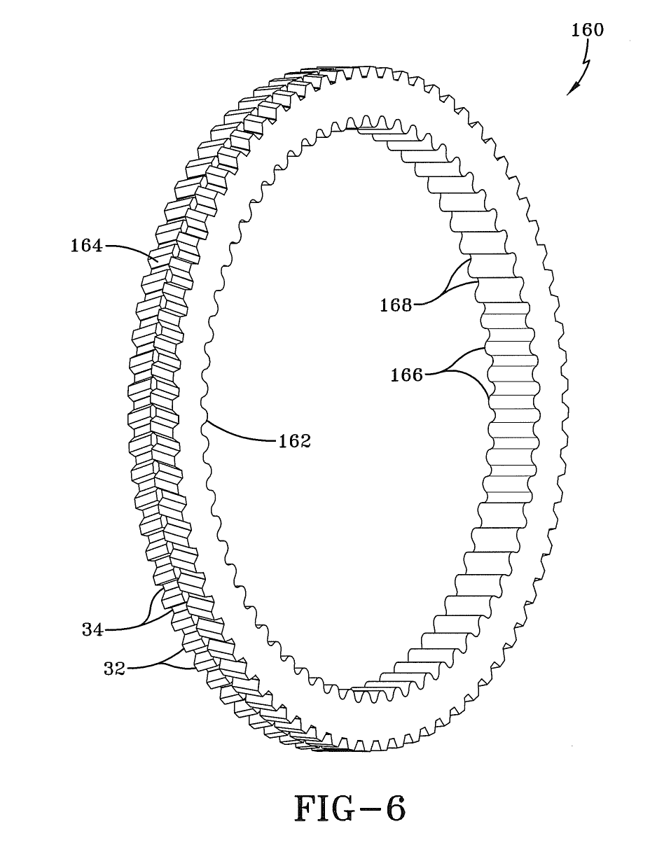

With reference now to FIGS. 3-6, a wheel 100 made according to this invention will now be described. It should be noted that the wheel 100 could be used as one or more pulleys in a belt system (such as shown in FIG. 1) or as one or more sprockets in a chain system (such as shown in FIG. 2). The wheel 100 has two primary components, a hub 120 and a sleeve 160. The hub 120 may have an aperture 122 that receives a shaft (not shown) for rotation with the shaft or for rotation with respect to the shaft. The hub 120 may also have one or more connection openings 124, six shown, for use in connecting the wheel 100 to another component (not shown) for rotation with the wheel 100. It should be noted that neither the aperture 122 nor any of the openings 124 are required for this invention. The hub 120 may also have an outer ring 126 with a radialy-outward facing outer surface 128 used to connect the hub 120 to the sleeve 160. For the embodiment shown, the outer surface 128 has a plurality of substantially axially aligned teeth 130 separated by channels 132. The hub 120 may be formed of any material or materials chosen with sound engineering judgment. In some applications it is desirable to form the hub 120 of metal.

With continuing reference to FIGS. 3-6, the sleeve 160 may be ring shaped with a radialy-inward facing inner surface 162 and a radialy-outward facing outer surface 164. The outer surface 164 defines a band engagement surface that operatively engages a corresponding band. For the embodiment shown, the band engagement surface 164 includes the previously noted teeth 32 separated by cavities 34 for engagement with the toothed side 12 of the belt 10. Thus, the sleeve 160 shown in FIGS. 3, 4 and 6 is intended for use as a pulley wheel. However, the band engagement surface 164 can, in another embodiment, include the previously noted teeth 60 formed on the outer surface of a drive or driven sprocket 54, 56 for engagement with the openings 58 in the chain 52 as shown in FIG. 2. Such a sleeve is intended for use as a sprocket wheel. The inner surface 162 has substantially axially aligned projections 166 separated by substantially axially aligned grooves 168 to meshingly engage with the outer surface 128 of the hub 120. More specifically, the projections 166 are received in the channels 132 while the teeth 130 are simultaneously received in the grooves 168. The connection between the hub 120 and the sleeve 160 is tight enough to provide for the transmission of torque between the hub 120 and the sleeve 160 yet includes enough clearance to permit the sleeve 160 to simultaneously “float” or move axially with respect to the hub 120. The wheel 100 can thus transmit torque while the sleeve 160 moves axially, as needed.

Still referring to FIGS. 3-6, the sleeve 160 may be formed of any material or materials chosen with sound engineering judgment. In one embodiment, the sleeve 160 is formed of a metal. The metal may be of the same type used to form the hub 120. In another embodiment, the sleeve 160 is formed of a plastic. The plastic sleeve 160 may be shaped in any conventional manner. In one embodiment, the plastic sleeve 160 is made in an injection molding process. This provides a low cost manufacturing alternative that is especially useful when relatively large volumes are required. In another embodiment, the plastic sleeve 160 may be machined. This manufacturing alternative is especially useful when relatively small volumes are required. The use of plastic in forming the sleeve 160 may have advantages beyond cost. Because the plastic has a lower elastic modulus than a metal component, the load sharing ability of the sleeve 160 with the corresponding belt would be increased. The use of a plastic sleeve 160 with its lower elastic modulus may also decrease belt debris damage.

With reference now to all the FIGURES, the operation of the wheel 100 with a band system will now be described. Once the band system (whether a belt system 20 such as shown in FIG. 1 or a chain system 50 such as shown in FIG. 2) is assembled, it is driven. The band system 20, 50 may be driven in any manner chosen with sound engineering judgment such as driving or rotating one or more drive wheels 22, 54. As long as the band system 20, 50 remains perfectly aligned, the sleeve 160 will remain substantially axially centered with the hub 120. However, if the band 10, 52 becomes misaligned with respect to the wheel 100, this misalignment will create a force on the band 10, 52 urging the band 10, 52 out of centered engagement with the band engagement surface 164 of the wheel 100. With this invention, however, such a misalignment force will simply cause the sleeve 160 to float or move axially with respect to the hub 120 until the misalignment force ceases and proper alignment is achieved. This axial movement occurs as the inner surface 162 of the sleeve 160 slides with respect to the outer surface 128 of the hub 120. It should be noted that this axial movement occurs automatically whenever an axial misalignment force is created. It should also be noted that this axial movement can occur in either axial direction and to any axial distance up to the width of the sleeve 160. Thus, for example, a misalignment force may cause the sleeve 160 to move a certain distance in an axial direction. If the misalignment force subsequently worsened, the additional misalignment force would cause the sleeve 160 to move an additional distance in the same axial direction. If, alternatively, the misalignment force subsequently lessened, the reduced misalignment force would cause the sleeve 160 to move a certain distance in the opposite axial direction. In every case, proper alignment is achieved as the wheel self-aligns whenever a misalignment force is created, increased, or reduced.

With continuing reference to all the FIGURES, if the sleeve 160 becomes ineffective for any reason (a damaged outer band engagement surface 164, for example) it is only necessary to: (1) remove the band 10, 52 from the wheel 100; (2) axially slide the ineffective sleeve off of the hub 120; (3) replace the ineffective sleeve with a new sleeve; and, (4) reattach the band 10, 52 to the wheel 100. Note that this is easier and less expensive than known methods which require the entire wheel to be replaced.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A wheel comprising:
a hub comprising an outer surface having a plurality of substantially axially aligned teeth;
a sleeve comprising:
(a) an inner surface having a plurality of substantially axially aligned grooves that engage the teeth of the hub; and,
(b) an outer band engagement surface; and,
wherein the sleeve can move axially with respect to the hub while the wheel transmits torque between the hub and an associated band.

2. The wheel of claim 1 wherein the sleeve is formed of a metal.

3. The wheel of claim 1 wherein the sleeve is formed of a plastic.

4. The wheel of claim 3 wherein the sleeve is formed of an injection moldable plastic.

5. The wheel of claim 1 wherein the wheel is a drive wheel.

6. The wheel of claim 1 wherein the wheel is a driven wheel.

7. The wheel of claim 1 wherein the wheel is a pulley.

8. The wheel of claim 1 wherein the wheel is a sprocket.

9. The wheel of claim 1 wherein the hub has an aperture that receives an associated shaft.

10. A band system comprising:
a first wheel;
a second wheel comprising:
(1) a hub comprising an outer surface having a plurality of substantially axially aligned teeth;
(2) a sleeve comprising:
(a) an inner surface having a plurality of substantially axially aligned grooves that engage the teeth; and,
(b) an outer band engagement surface;
a band that operatively engages the first wheel and that comprises at least one surface having a plurality of teeth that engage the outer band engagement surface of the sleeve of the second wheel; and,
wherein the sleeve of the second wheel can move axially with respect to the hub of the second wheel while the second wheel transmits torque between the hub of the second wheel and the band.

11. The band system of claim 10 wherein the band is a belt and the first and second wheels are pulleys.

12. The band system of claim 10 wherein the band is a chain and the first and second wheels are sprockets.

13. The band system of claim 10 wherein the first wheel comprises:
(1) a hub comprising an outer surface having a plurality of substantially axially aligned teeth;
(2) a sleeve comprising:
(a) an inner surface having a plurality of substantially axially aligned grooves that engage the teeth; and,
(b) an outer band engagement surface that operatively engages the band; and,
wherein the sleeve of the first wheel can move axially with respect to the hub of the first wheel while the first wheel transmits torque between the hub of the first wheel and the band.

14. A method comprising the steps of:
providing a first wheel;
providing a second wheel comprising a hub and a first sleeve having an inner surface that engages the hub and an outer band engagement surface;
providing a band that operatively engages the first wheel and the band engagement surface of the second wheel;
driving the band system to thereby transmit torque between the band and the first and second wheels;
moving the first sleeve axially in a first direction with respect to the hub to align the band with respect to the second wheel.

15. The method of claim 14 wherein prior to the step of, providing a band that operatively engages the first wheel and the band engagement surface of the second wheel, the method comprises the step of:
replacing the first sleeve with a second sleeve having an inner surface that engages the hub and an outer band engagement surface.

16. The method of claim 14 further comprising the steps of:
providing an outer surface of the hub with a plurality of substantially axially aligned teeth;
providing the inner surface of the first sleeve with a plurality of substantially axially aligned grooves that engage the teeth; and,
wherein the step of, moving the first sleeve axially in a first direction with respect to the hub, comprises the step of axially sliding the inner surface of the first sleeve with respect to the hub.

17. The method of claim 14 wherein the step of, moving the first sleeve axially in a first direction with respect to the hub, occurs automatically as the band tends to become misaligned with respect to the first and second wheels.

18. The method of claim 17 further comprising the steps of:
moving the first sleeve further axially in the first direction with respect to the hub to align the band with respect to the second wheel as the band tends to become further misaligned.

19. The method of claim 17 further comprising the steps of:
moving the first sleeve axially in a second direction with respect to the hub to align the band with respect to the second wheel as the band tends to become less misaligned.

20. The method of claim 14 wherein the step of, driving the band system, comprises the step of rotating the second wheel as the drive wheel.
